(19) United States
(12) Patent Application Publication
(10) Pub. No.: US 2025/0062479 A1
(43) Pub. Date: Feb. 20, 2025

(54) PRESSURE RELIEF OF BATTERY CELL OF VEHICLE

(71) Applicant: GM Global Technology Operations LLC, Detroit, MI (US)

(72) Inventors: Fengkun Wang, Rochester Hills, MI (US); Liang Xi, Northville, MI (US); Lei Wang, Rochester Hills, MI (US); Rachel Hysong, Royal Oak, MI (US); SriLakshmi Katar, Troy, MI (US)

(21) Appl. No.: 18/449,897

(22) Filed: Aug. 15, 2023

(51) Int. Cl. H01M 50/30; B60L 50/64; H01M 50/249; H01M 50/289

(52) U.S. Cl. CPC H01M 50/30; B60L 50/64; H01M 50/249; H01M 50/289; H01M 2200/20; H01M 2220/20

(57) ABSTRACT

A battery assembly of a vehicle includes a battery cell, and a cell holder in which the battery cell is located. The cell holder includes a holder base, and one or more holder legs extending downwardly from the holder base. A plurality of cell vents extend through the holder base. The plurality of cell vents are configured to relieve a pressure of the battery cell in the occurrence of a thermal event.

### INTRODUCTION

The subject disclosure relates to vehicles, and in particular to cooling of battery packs of vehicles.

High capacity battery packs are utilized in many consumer and industrial sectors categorically including transportation and power grid applications. High capacity battery packs are known to include a plurality of battery pack modules allowing for flexibility in configurations and adaptation to application requirements.

Such battery packs generate heat and internal pressure when placed under load. Heat may have a detrimental effect on battery efficiency and/or battery life, and a buildup of internal pressure during a thermal event in the battery may result in failure of the battery pack. Accordingly, removing the heat and lowering the internal pressure provides a benefit to battery operation.

### SUMMARY

In one exemplary embodiment, a battery assembly of a vehicle includes a battery cell, and a cell holder in which the battery cell is located. The cell holder includes a holder base, and one or more holder legs extending downwardly from the holder base. A plurality of cell vents extend through the holder base. The plurality of cell vents are configured to relieve a pressure of the battery cell in the occurrence of a thermal event.

In addition to one or more of the features described herein, a cell vent of the plurality of cell vents extends through a holder leg of the one or more holder legs.

In addition to one or more of the features described herein, the battery cell includes an electrode stack, a cell housing in which the electrode stack is positioned, and one or more stack supports extending from a stack base of the electrode stack.

In addition to one or more of the features described herein, the one or more stack supports define a cell gap between the electrode stack and a housing base of the cell housing.

In addition to one or more of the features described herein, a cell vent of the plurality of cell vents is positioned between a stack support and a lateral end of the battery cell.

In addition to one or more of the features described herein, the battery cell has a vertical height greater than a lateral width.

In addition to one or more of the features described herein, the battery cell is a lithium-ion battery cell.

In addition to one or more of the features described herein, the cell holder further includes one or more holder sidewalls extending upwardly from the holder base.

In addition to one or more of the features described herein, one or more side cell vents are positioned in the one or more holder sidewalls.

In addition to one or more of the features described herein, the one or more cell vents are one or more of circular, oval, square, rectangular, or hexagonal.

In another exemplary embodiment, a vehicle includes a vehicle body, one or more wheels connected to the vehicle body, and a propulsion system operably connected to the one or more wheels configured to propel the vehicle. The propulsion system includes at least one battery assembly. The battery assembly includes a battery cell, and a cell holder in which the battery cell is positioned. The cell holder includes a holder base, and one or more holder legs extending downwardly from the holder base. A plurality of cell vents extend through the holder base. The plurality of cell vents are configured to relieve a pressure of the battery cell in the occurrence of a thermal event.

In addition to one or more of the features described herein, a cell vent of the plurality of cell vents extends through a holder leg of the one or more holder legs.

In addition to one or more of the features described herein, the battery cell includes an electrode stack, a cell housing in which the electrode stack is positioned, and one or more stack supports extending from a stack base of the electrode stack.

In addition to one or more of the features described herein, the one or more stack supports define a cell gap between the electrode stack and a housing base of the cell housing.

In addition to one or more of the features described herein, a cell vent of the plurality of cell vents is positioned between a stack support and a lateral end of the battery cell.

In addition to one or more of the features described herein, the battery cell has a vertical height greater than a lateral width.

In addition to one or more of the features described herein, the battery cell is a lithium-ion battery cell.

In addition to one or more of the features described herein, the cell holder further includes one or more holder sidewalls extending upwardly from the holder base.

In addition to one or more of the features described herein, one or more side cell vents are positioned in the one or more holder sidewalls.

In addition to one or more of the features described herein, the one or more cell vents are one or more of circular, oval, square, rectangular, or hexagonal.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic illustration of an embodiment of a vehicle;

FIG. 2 is a schematic illustration of an embodiment of a battery assembly;

FIG. 3 is an illustration of an embodiment of a battery cell of a battery assembly;

FIG. 4. is an illustration of an embodiment of a battery cell in a cell holder;

FIG. 5 is an illustration of another embodiment of a battery cell in a cell holder; and

FIG. 6 is an illustration of yet another embodiment of a battery cell in a cell holder.

### DETAILED DESCRIPTION

The following description is merely exemplary in nature and is not intended to limit the present disclosure, its application or uses. It should be understood that throughout the drawings, corresponding reference numerals indicate like or corresponding parts and features.

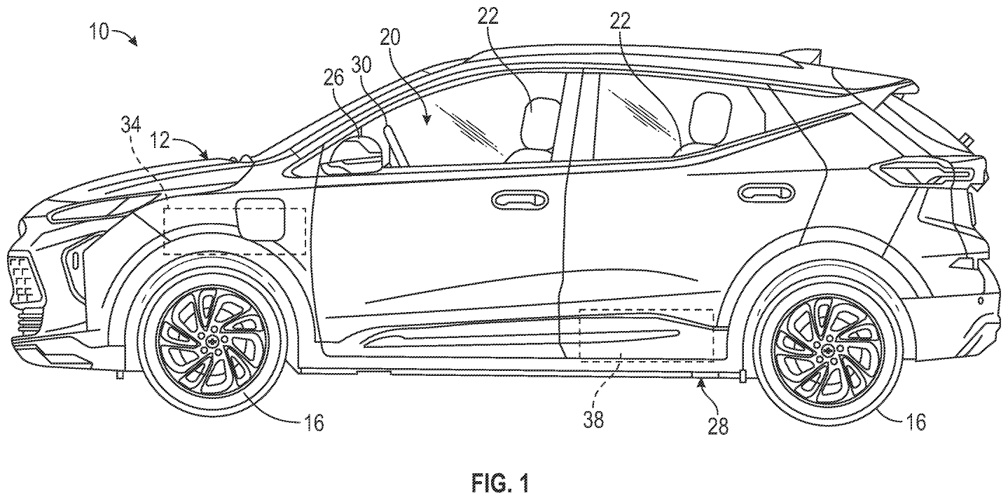

In accordance with an exemplary embodiment a vehicle, in accordance with a non-limiting example, is indicated generally at 10 in FIG. 1. Vehicle 10 includes a body 12 supported on a plurality of wheels 16. In a non-limiting example, two of the plurality of wheels 16 are steerable. Body 12 defines, in part, a passenger compartment 20 having seats 22 positioned behind a dashboard 26. A steering control 30 is arranged between seats 22 and dashboard 26. Steering control 30 is operated to control orientation of the steerable wheel(s). Vehicle 10 includes an electric motor 34 connected to a transmission that provides power to one or more of the plurality of wheels 16. A rechargeable energy storage system (RESS) or battery assembly 38 provides power to electric motor 34.

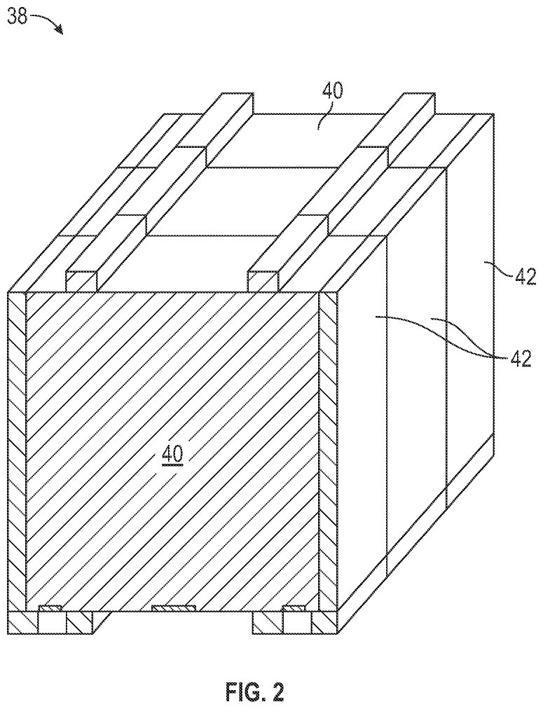

Referring now to FIG. 2, an embodiment of a battery assembly 38 is illustrated. The battery assembly 38 is in some embodiments a Lithium-ion battery, but one skilled in the art will readily appreciate that other suitable types of batteries may be utilized. The battery assembly 38 includes one or more battery cells 40 disposed in a cell holder 42. In some embodiments, each battery cell 40 is located in its own cell holder 42 such as shown in FIG. 1, while in other embodiments two or more battery cells 40 may reside in a common cell holder 42.

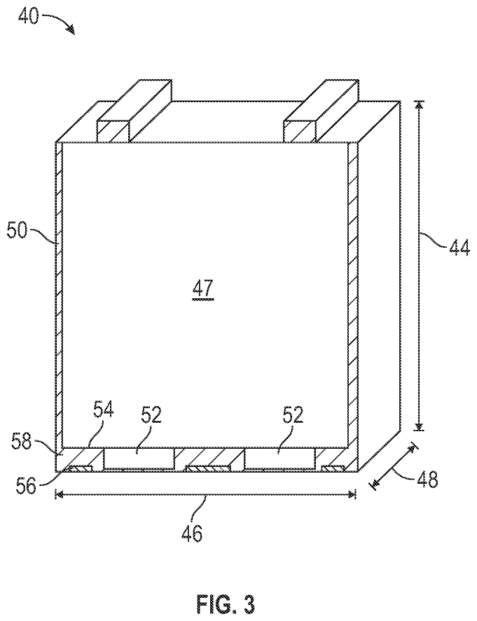

In some embodiments, the battery cell 40 is a “tall” prismatic can battery cell 40. In such a structure, the battery cell 40, as shown in FIG. 3, has a vertical cell height 44 that is greater than both a cell width 46 and a cell depth 48. In some embodiments, an aspect ratio of cell height 44 to cell width 46 is greater than 2:1. The battery cell 40 includes an electrode stack 47 disposed in a cell housing 50. The electrode stack 47 is supported in the cell housing 50 by one or more stack supports 52 extending between a stack bottom surface 54 and a housing base 56 of the cell housing 50. The stack supports 52 define a vertical offset of the stack bottom surface 54 from the housing base 56, which is referred to herein as a cell gap 58.

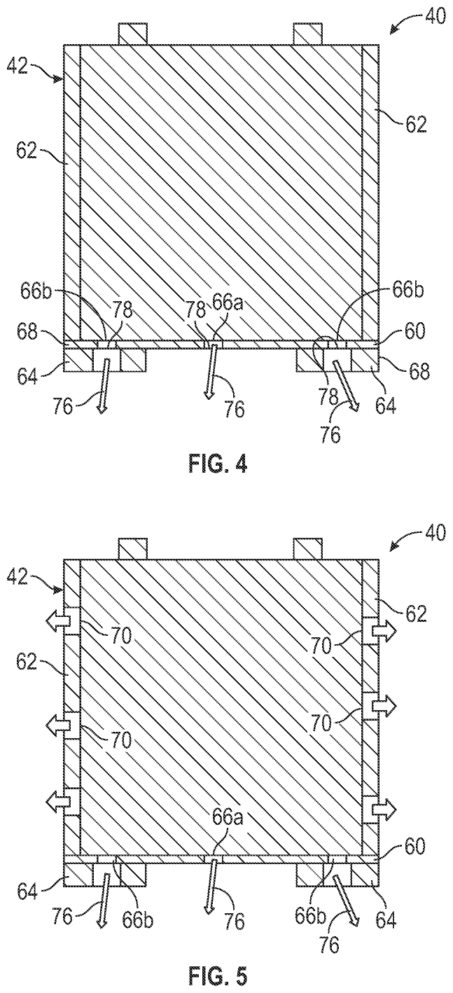

The cell holder 42, as shown in FIG. 4, includes a holder base 60 from which holder sidewalls 62 extend upwardly. In some embodiments, holder legs 64 extend downwardly from the holder base 60. In the event of a thermal event such as a thermal runaway of the battery cell 40, internal gas pressure in the battery cell 40 grows and the battery cell 40 risks failure when the internal pressure continues to increase. To reduce the internal pressure, a plurality of cell vents 66 defined as openings in the cell holder 42, are located in the holder base 60. In one configuration, as shown in FIG. 4, three cell vents 66 are located in the holder base 60, with a first cell vent 66a located at a lateral center of the holder base 60 and two second cell vents 66b located at or near lateral ends 68 of the holder base 60. In some embodiments, such as shown, the second cell vents 66b extend through the holder legs 64 of the cell holder 42. The use of the cell vents 66 improves removal of high pressure gasses from the battery cell 40 to prevent rupture of the battery cell 40 during a thermal event. While three cell vents 66 are illustrated and described herein, one skilled in the art will readily appreciate that other quantities of cell vents 66 may be utilized. Locating second cell vents 66b close to the lateral ends 68 quickly directs hot gas flow 76 out of the cell holder 42, thus effectively and quickly limiting the internal pressure increase of the battery cell 40 during a thermal event. In some embodiments, the vents 66 include pressure-sensitive vent covers 78 over the vent 66 openings. When the internal pressure exceeds the predetermined threshold, the vent covers 78 open, thus opening the vents 66 allowing the pressure to be relieved.

The cell vents 66 are in some embodiments circular in shape, but the use of cell vents 66 of other cross-sectional shapes, such as oval, square, rectangular, hexagonal, or other shapes, are contemplated within the scope of the present disclosure. Further, while in some embodiments the cell vents 66 are identical in shape and/or size, in other embodiments the size and/or shape of the cell vents 66 of the cell holder 42 may be varied to meet the pressure relief requirements of the battery cell 40.

In another embodiment, illustrated in FIG. 5, the cell holder 42 may include one or more side cell vents 70 disposed in the cell holder 42, in particular in one or more of the holder sidewalls 62. The side cell vents 70 may be utilized in addition to or in place of the cell vents 66. Similar to the cell vents 66, the side cell vents 70 are in some embodiments circular in shape, but the use of side cell vents 70 of other cross-sectional shapes, such as oval, square, rectangular, hexagonal, or other shapes, are contemplated within the scope of the present disclosure. Further, while in some embodiments the side cell vents 70 are identical in shape and/or size, in other embodiments the size and/or shape of the side cell vents 70 of the cell holder 42 may be varied to meet the pressure relief requirements of the battery cell 40.

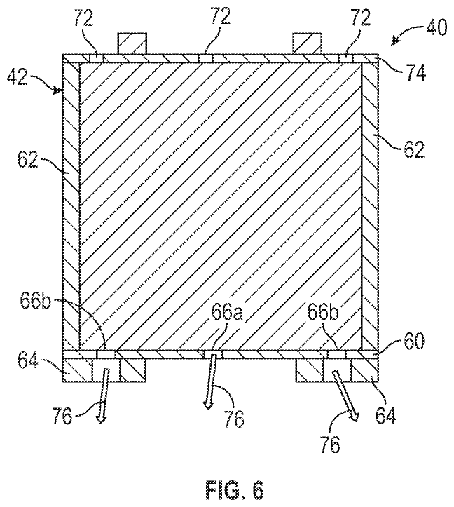

In yet another embodiment, illustrated in FIG. 6, the cell holder 42 may include one or more top cell vents 72 disposed in a top plate 74 of the cell holder 42. The top cell vents 72 may be utilized in addition to or in place of the cell vents 66 and/or the side cell vents 70. Similar to the cell vents 66, the top cell vents 72 are in some embodiments circular in shape, but the use of top cell vents 72 of other cross-sectional shapes, such as oval, square, rectangular, hexagonal, or other shapes, are contemplated within the scope of the present disclosure. Further, while in some embodiments the top cell vents 72 are identical in shape and/or size, in other embodiments the size and/or shape of the top cell vents 72 of the cell holder 42 may be varied to meet the pressure relief requirements of the battery cell 40.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A battery assembly of a vehicle, comprising:
a battery cell;
a cell holder in which the battery cell is disposed, the cell holder including:
a holder base;
one or more holder legs extending downwardly from the holder base; and
a plurality of cell vents extending through the holder base, wherein the plurality of cell vents are configured to relieve a pressure of the battery cell.

2. The battery assembly of claim 1, wherein a cell vent of the plurality of cell vents extends through a holder leg of the one or more holder legs.

3. The battery assembly of claim 1, wherein the battery cell includes:
an electrode stack;
a cell housing in which the electrode stack is disposed; and
one or more stack supports extending from a stack base of the electrode stack.

4. The battery assembly of claim 3, wherein the one or more stack supports define a cell gap between the electrode stack and a housing base of the cell housing.

5. The battery assembly of claim 3, wherein a cell vent of the plurality of cell vents is disposed between a stack support and a lateral end of the battery cell.

6. The battery assembly of claim 1, wherein the battery cell has a vertical height greater than a lateral width.

7. The battery assembly of claim 1, wherein the battery cell is a lithium-ion battery cell.

8. The battery assembly of claim 1, wherein the cell holder further includes one or more holder sidewalls extending upwardly from the holder base.

9. The battery assembly of claim 8, further comprising one or more side cell vents disposed in the one or more holder sidewalls.

10. The battery assembly of claim 1, wherein the plurality of cell vents are one or more of circular, oval, square, rectangular, or hexagonal.

11. A vehicle, comprising:
a vehicle body;
one or more wheels connected to the vehicle body; and
a propulsion system operably connected to the one or more wheels configured to propel the vehicle, the propulsion system including at least one battery assembly, the battery assembly including:
a battery cell;
a cell holder in which the battery cell is disposed, the cell holder including:
a holder base;
one or more holder legs extending downwardly from the holder base; and
a plurality of cell vents extending through the holder base, wherein the plurality of cell vents are configured to relieve a pressure of the battery.

12. The vehicle of claim 11, wherein a cell vent of the plurality of cell vents extends through a holder leg of the one or more holder legs.

13. The vehicle of claim 11, wherein the battery cell includes:
an electrode stack;
a cell housing in which the electrode stack is disposed; and
one or more stack supports extending from a stack base of the electrode stack.

14. The vehicle of claim 13, wherein the one or more stack supports define a cell gap between the electrode stack and a housing base of the cell housing.

15. The vehicle of claim 13, wherein a cell vent of the plurality of cell vents is disposed between a stack support and a lateral end of the battery cell.

16. The vehicle of claim 11, wherein the battery cell has a vertical height greater than a lateral width.

17. The vehicle of claim 11, wherein the battery cell is a lithium-ion battery cell.

18. The vehicle of claim 11, wherein the cell holder further includes one or more holder sidewalls extending upwardly from the holder base.

19. The vehicle of claim 18, further comprising one or more side cell vents disposed in the one or more holder sidewalls.

20. The vehicle of claim 11, wherein the plurality of cell vents are one or more of circular, oval, square, rectangular, or hexagonal.
